(19) United States
(12) Patent Application Publication
(10) Pub. No.: US 2022/0295014 A1
(43) Pub. Date: Sep. 15, 2022

(54) MULTI-GROUP VIRTUAL EVENT SYSTEM

(71) Applicant: Virtuelly Inc., Seattle, WA (US)

(72) Inventor: Ankit DHAWAN, Seattle, WA (US)

(21) Appl. No.: 17/694,538

(22) Filed: Mar. 14, 2022

Related U.S. Application Data
(60) Provisional application No. 63/160,444, filed on Mar. 12, 2021.

(51) Int. Cl. H04N 7/15; G06T 19/00; G06T 13/40

(52) U.S. Cl. CPC H04N 7/157; G06T 19/006; G06T 13/40; G06Q 50/01

(57) ABSTRACT

A multi-group virtual event system providing enabling users to attend a virtual event with a private group. Each attendee in the private group is in network communication with the other users in the group and with an event host, but separated from any other private groups. This arrangement provides attendees with the social experience of attending an event with a private group while maintaining the convenience of virtual attendance.

### CROSS-REFERENCES

The following applications and materials are incorporated herein, in their entireties, for all purposes: U.S. Provisional Patent Application Ser. No. 63/160,444, filed Mar. 12, 2021.

### FIELD

This disclosure relates to systems and methods for virtual events. More specifically, the disclosed embodiments relate to creating, hosting, and participating in virtual events.

### INTRODUCTION

Virtual events and video conferencing is quickly becoming a regular, and often necessary, part of the modern-day lifestyle. As more live events move into the digital space, the social aspect of attending events with friends and colleagues is quickly diminishing. A virtual event system that maintains the social aspect of event-going would maintain the experience of a live event while providing the convenience of a digital event.

### SUMMARY

The present disclosure provides systems, apparatuses, and methods relating to virtual events.

In some embodiments, a computer implemented method for hosting a virtual event may include: receiving, via a user interface, a plurality of login credentials, each login credential corresponding to a respective attendee and comprising a respective group identifier; grouping the attendees into one or more groups based on the respective group identifiers; restricting video and audio communication between attendees to include only other attendees of the same group; and sending digital media of the host including a video stream of the host and/or an audio stream of the host to each of the attendees.

In some embodiments, a data processing system for hosting a virtual event may include: one or more processors; a memory; and a plurality of instructions stored in the memory and executable by the one or more processors to: receive, via a user interface, a plurality of login credentials, each login credential corresponding to a respective attendee and comprising a respective group identifier; group the attendees into one or more groups based on the respective group identifiers; restrict video and audio communication between attendees to include only other attendees of the same group; and send digital media of the host including a video and/or audio stream to each attendee.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram depicting a multi-group virtual event system in accordance with the present disclosure.

FIG. 2 is a flow chart depicting steps of an illustrative method for assigning attendees to groups in accordance with the present disclosure.

FIG. 3 is a schematic diagram depicting aspects of a multi-group virtual event in accordance with the present disclosure.

FIG. 4 is a flow chart depicting steps of an illustrative method for initializing groups.

FIG. 5 is a schematic diagram depicting a data processing system in accordance with the present disclosure.

FIG. 6 is a schematic diagram depicting a network data processing system in accordance with the present disclosure.

### DETAILED DESCRIPTION

Various aspects and examples of a multi-group virtual event system are described below and illustrated in the associated drawings. Unless otherwise specified, a virtual event system in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first,” “second,” and “third” are used to distinguish or identify various members of a group, or the like, and are not intended to show serial or numerical limitation.

“AKA” means “also known as,” and may be used to indicate an alternative or corresponding term for a given element or elements.

“Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (Al) accelerators, digital signal processors (DSPs), and/or any other suitable combination of logic hardware.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, a multi-group virtual event system may enable attendees of a virtual event (e.g., video conference/chat/stream/meeting) to form a private group and attend the event together. The attendees may communicate with each other within their private group while simultaneously viewing and/or listening to the content of the virtual event isolated from other attendee groups (i.e., in isolation with respect to other groups).

Technical solutions are disclosed herein for virtual events, video conferencing, and video presentation. Specifically, the disclosed system/method addresses a technical problem tied to computer technology and arising in the realm of large-scale video conferencing and virtual event participation, for example the technical problem of providing audio and video privacy to groups of virtual attendees.

Aspects of the virtual event system may be embodied as a computer method, computer system, or computer program product. Accordingly, aspects of the virtual event system may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the virtual event system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the virtual event system may be written in one or any combination of programming languages, including an object-oriented programming language (such as Java, C++), conventional procedural programming languages (such as C), and functional programming languages (such as Haskell). Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the virtual event system may be described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s).

Additionally, or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the virtual event system. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of illustrative virtual event systems as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Multi-Group Virtual Event System

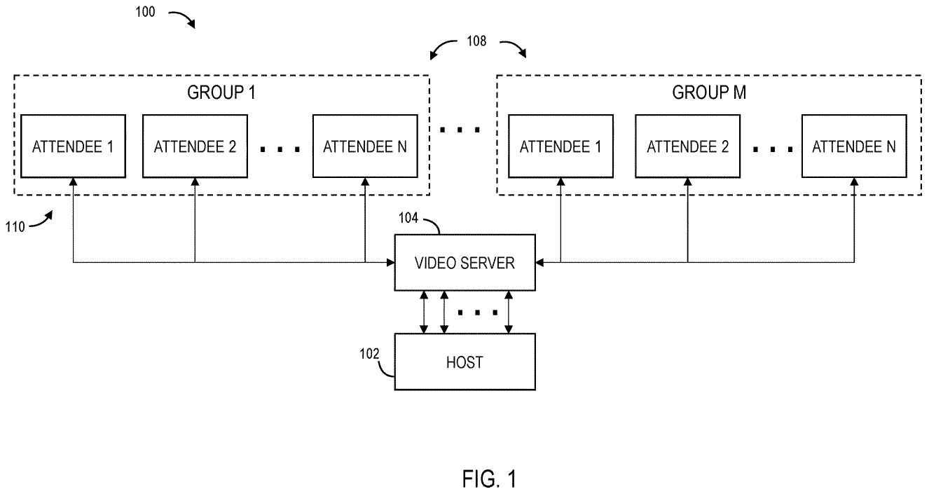

As shown in FIGS. 1-4, this section describes an illustrative multi-group virtual event system 100, an example of the virtual event system described above.

With reference to FIG. 1, virtual event system 100 may be a browser-based or standalone application configured to provide access to a virtual event (e.g., webinars, virtual reality (VR) based events, events held in 3D virtual spaces, video meetings, video conferences, and/or other video/audio streaming events) provided by an event host 102 and hosted on a video server 104 to a plurality of groups 108, each group having one or more attendees 110. In some examples, the virtual event includes multiple hosts.

Attendees 110 may log into the virtual event utilizing system 100 to stream the content of the event to their personal electronic devices (e.g., smartphone, home computer, television, VR headsets, etc.) in concert with the other attendees. Virtual event system 100 is configured to automatically establish groups 108 and categorically place each attendee 110 into one of the groups based on a set of operating criteria, described in more depth below.

In this manner, virtual event system 100 is configured to virtually simulate the experience of a physical, real-world event by enabling attendees of the virtual event to simultaneously attend the event together while remaining in private groups. Accordingly, while all of the attendees/groups may view the virtual event, the attendees of each individual group are able to communicate privately with each other in the event context, without being exposed to any other groups. In some examples, the attendees in a group can see and interact with other members of their group or a selection of groups. In some examples, all attendees are restricted to viewing only the host and/or the virtual content provided by host 102.

In some examples, host 102 selectively enables two-way communication with all attendees 110, such as in the case of a question-and-answer session between the host and the attendees. In some examples, host 102 can selectively enable two-way communication with a single attendee, a single group, a plurality of attendees, and/or a plurality of groups.

In some examples, the virtual event is provided in a virtual space such as a 3D virtual environment, VR space, etc. In such examples, attendees 110 may view the content provided by host 102 and see avatar representations of their fellow group members rendered in the virtual space. Attendees 110 may interact with their group members via audio, virtual gestures, and other suitable methods. In some examples, attendees can also see attendees of other groups, or some indication of those attendees' presence, but remain isolated in terms of communication. In the example of a virtual space, the system may utilize proximity-based chat (AKA proximity chat) between members of a group. For example, the relative audio volumes of group members may be dependent on a virtual distance between the group members. In some examples, there is a threshold virtual distance at which audio begins (or stops) transmitting. For example, when attendees are farther away than the specified threshold distance from each other, they cannot hear each other. The threshold distance may be uniquely selected for each attendee or group, or universally selected for all attendees.

The relative sound volumes of attendees 110 can be further managed in either the virtual space embodiment(s), the video conferencing/presentation embodiment(s), or both. System 100 identifies the loudest attendee(s) by sampling the overall volume of all attendees and identifying attendees which contribute the largest portion of overall volume. In some examples, system 100 samples overall volume three times per second, though other sampling rates may be utilized. In some examples, system 100 automatically dampens or reduces the volume of any attendee whose volume exceeds a predetermined volume threshold, whether in terms of magnitude or percentage of total group volume. In some examples, host 102 (or a select number of attendees) may select one or more attendees and designate them as “spotlight” attendees, such as while participating in a virtual game. Accordingly, system 100 may automatically dampen the volume of all attendees except those that are in the spotlight role.

In some examples system 100 may utilize a noisiness measure to measure and detect noisy attendees. The noisiness measure is monitored either by an event coordinator/user or by the system (e.g., automatically), and is utilized to identify noisy participants that may need to have their audio volume reduced or muted. The noisiness measure is determined by sampling the volume of each attendee, e.g., at a predetermined sampling rate (e.g., every three seconds) and adding the sampled volume to a sustained noise level measure. In some examples, the noisiness measure is a reduced running sum of the previous noisiness measure with the currently sampled volume added to it.

In other words:

noisiness_measure₁={reduction_{coefficient}}*noisiness_measure₀+sampling_volume

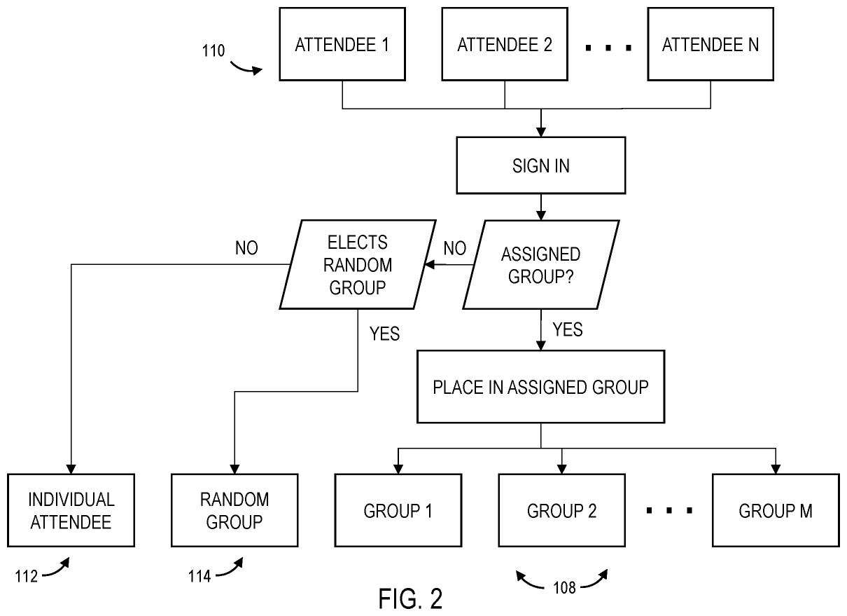

Turning to FIG. 2, when the day/time arrives for the virtual event, each attendee 110 may sign into system 100 (e.g., through a network user interface). If the attendee's login information includes a group identifier, the attendee is automatically added to that respective group 108. Additionally, or alternatively, an attendee may manually input a known group ID to join an existing group. If an attendee attempts to sign into the system without a group, the attendee may be prompted by the system. In some examples, an option is offered to be randomly assigned to a group. In cases where the attendee does not elect to join a random group, the attendee may attend the event individually (i.e., in a group of one, including only themselves, as shown at 112). In some examples, attendees electing to join a random group are grouped together with other attendees who have elected to join a random group, an example of which is depicted at 114. In some examples, attendees electing to join a random group are automatically added to an existing group (e.g., if the existing group opted into allowing another member).

When host 102 begins the virtual event, each of attendees 110 in each of groups 108 are able to view the content provided by the host. For example, this may include live video and/or live audio of the host, pre-generated media provided by the host (e.g., video, music, etc.), screen sharing, video and/or audio of a live event stage, and/or other suitable content for the virtual event. In some examples, host 102 may selectively send different video and audio streams, such as a live video having pre-recorded accompanying background music. Additionally, attendees 110 within each group may see other attendees in their group, while remaining isolated from any or all of the other groups.

In some examples, host 102 is able see all of attendees 110 from all of the groups. In some examples, the host only sees a select few of the attendees at one time. For example, if the number of attendees is too large to reasonably view, the host may selectively view a portion or subset of the attendees. In some examples, the virtual event system may automatically cull the list of attendees visible to the host based on one or more provided criteria (e.g., the host may only view a single attendee from each group, all attendees from a single group, or another portion of attendees).

In some examples, the host can selectively bring one or more attendees into the virtual event (i.e., on screen) to be viewed by all other attendees. For example, if the host were performing a magic show, they may bring on one or more attendees as a volunteer to aid in the performance.

In some examples, host 102 may enable a full view of all groups 108, such that all attendees may see each other, regardless of group. Groups may be differentiated by a color coding (e.g., a unique border color for each member of a single group), on-screen spatial layout, or other visual indicator of different groups.

Within each group, the group members may selectively communicate through video and/or audio with a single one of the other group members, a selected subset of the group members, and/or all other group members, while simultaneously hearing the audio content of the virtual event and/or viewing the video content of the virtual event. For example, during the virtual event a group member may break away to a private audio chat with another group member without leaving the virtual event. Any participating attendee may selectively change and/or enable automatic changing of the level of the audio of the chat, virtual event, and/or both. Participating attendees may selectively change and/or enable automatic changing of the size and configuration of the displayed video feeds of the other group members, the virtual event, and/or both.

Additionally, or alternatively, within each group, the group members may selectively communicate textually with a single one of the other group members, a selected subset of the group members, and/or all other group members. For example, throughout the virtual event, attendees may utilize a group-wide chat and/or private messaging with another group member.

The audio and video of the virtual event may be handled and distributed to client devices of the attendees 110 by video server 104 utilizing a video server architecture.

System 100 may utilize a Selective Forwarding Unit (SFU) architecture. For example, a video and audio stream may be provided by all attendee devices (or a subset of the attendees) to the video server. The server may then selectively forward a subset of these streams to each attendee endpoint (e.g., based on each attendee's group membership). The specific subset forwarded to each attendee is dependent on which specific attendees a given attendee is interested in receiving (or authorized to receive) at any given point in time. For example, the subset of streams forwarded to each attendee may be based on group construction or digital event construction. In some examples, the specific subset forwarded to each attendee is further curtailed, e.g., based on screen-resolution, video layout, or user-provided instruction. In some examples, the system automatically adjusts the number and/or quality of the video streams based on a network connection.

Alternatively, a Multipoint Control Unit (MCU) architecture may be utilized. In these examples, the video server receives a video stream from each of the attendees and the host and combines them into thumbnail videos in a single video stream. A distinct stream with a requested layout and quality, based on endpoint bandwidth, is constructed for each endpoint (e.g., each individual attendee and/or host). The resulting video stream is then sent to the corresponding endpoint.

Alternatively, a Scalable Video Coding (SVC) architecture may be utilized. SVC is similar to SFU architecture, but the stream sent by each participant is sent in layers that progressively increase the quality of the video. A subset of these streams is sent to each endpoint based on an algorithm that determines which participants a given endpoint is interested in receiving at a given point in time (e.g., based on group construction). A benefit of this architecture is the video server individually determines the quality of each stream sent to an endpoint based on the endpoint's layout (e.g., the output display ratio of each attendee) and the endpoint's connectivity. Since the videos from each endpoint are sent to the server in layers, the quality may be adjusted by varying the number of layers that are sent to a given endpoint.

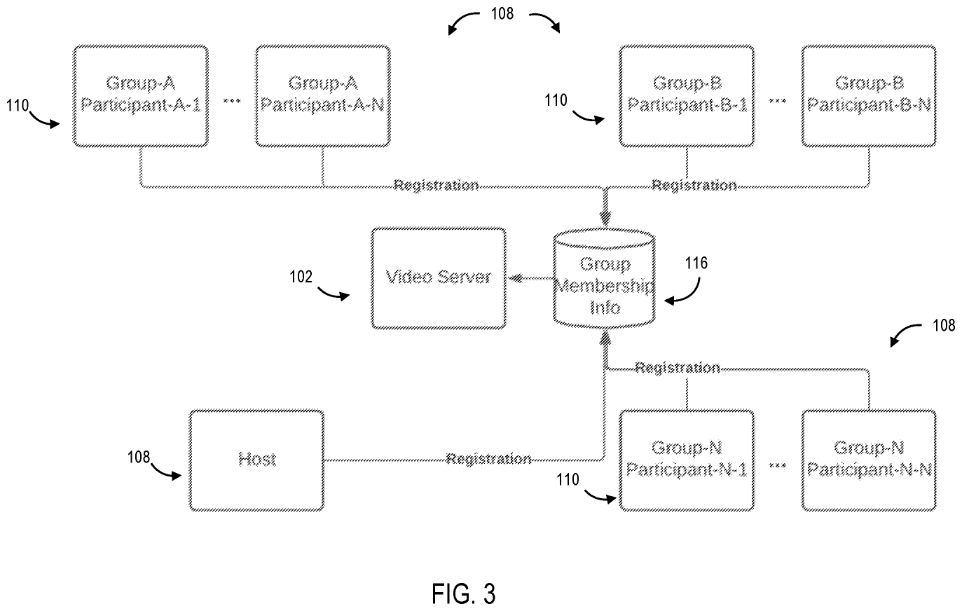

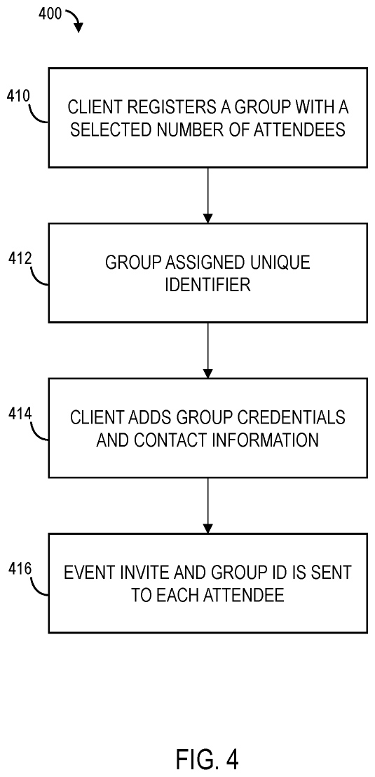

For the purpose of illustration, a simple example of a virtual event architecture is depicted in FIG. 3. Video server 104 is provided group membership data 116 regarding each of the attendees for each group. In general, group membership data 116 includes attendee credentials and group data provided by all of the participating clients (see FIG. 4 and method 400 described further below). This data may be provided when the group is initially registered in the virtual event system. The server utilizes this data to determine which audio/video streams are sent to each endpoint—namely a subset of the total streams comprising other members of the respective group and the host. As described above, in some examples, group membership may occur in conjunction with an attendee joining the virtual event at a later time (e.g., during the event).

With the group membership defined and recorded to the video server, the server is configured to send streams to each endpoint as depicted in the FIG. 4. For simplicity, the endpoint streams sent to the server are not shown explicitly, but each individual endpoint corresponds to the color coding of the individual streams.

The specific arrangement of streams sent to each endpoint may be selectively changed based on one or more criteria of the host and/or attendees. For example, as described above, the host may select one or more attendees and/or one or more groups to be included in the presentation and shown to the entire audience, in which case the data streams of those included attendees/groups would be routed to all attendees.

In some examples, an attendee can elect to watch and/or listen solely to the host, in which case the streams from any other attendee (e.g., other group members) would no longer be sent to their device. In some examples, an attendee can elect to stop watching and/or listening to the host. In some examples, changes to group-membership can be made during the virtual event (e.g., a new attendee may join, or a current attendee may leave).

Each attendee may selectively change the layout and/or quality of the streams presented on their device. For example, an attendee may choose not to include one or more groups members in their view and/or selectively change the quality of a video and/or audio stream.

An example of a group registration is depicted in FIG. 4 and illustrated in method 400, described below. Aspects of system 100 may be utilized in the method steps described below. Where appropriate, reference may be made to components and systems that may be used in carrying out each step. These references are for illustration and are not intended to limit the possible ways of carrying out any particular step of the method.

FIG. 4 is a flowchart illustrating steps performed in an illustrative method, and may not recite the complete process or all steps of the method. Although various steps of method 400 are described below and depicted in FIG. 4, the steps need not necessarily all be performed, and in some cases may be performed simultaneously or in a different order than the order shown.

Step 410 of method 400 includes a client registering a new group with system 100 and selecting a number of attendees. In some examples, the client may specify a range of values for the number of attendees or may specify an unknown number of attendees.

Step 412 of method 400 includes the automatic assignment of a unique group identifier associated with the group of attendees. The identifier may utilize a numeric value, an alphanumeric value, an alphabetic value, or another suitable identification system. The identifier can be used by the attendees to easily verify which group they have been assigned.

Step 414 of method 400 includes the client providing credentials and contact information for the attendees. In some examples, this includes primary credentials of the attendees, such as each attendee's full name, age, etc. In some examples, this may include second credentials and/or contact information, such as an email address, phone number, physical address, etc.

Step 416 includes sending each attendee a group invite for the virtual event, including the group identification

### B. Illustrative Data Processing System

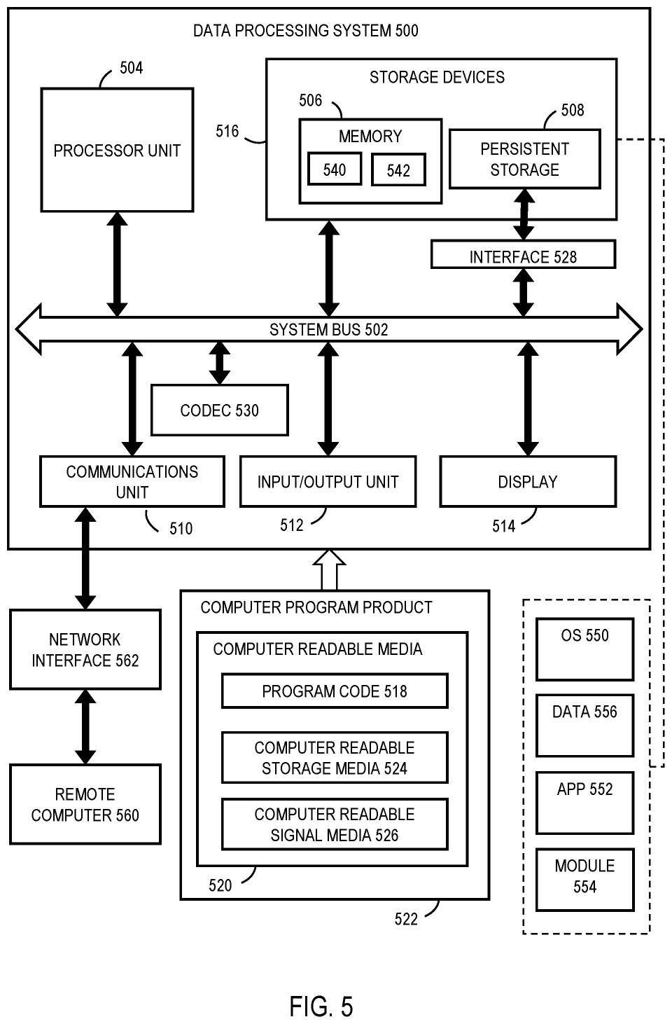

As shown in FIG. 5, this example describes a data processing system 500 (also referred to as a computer, computing system, and/or computer system) in accordance with aspects of the present disclosure. In this example, data processing system 500 is an illustrative data processing system suitable for implementing aspects of the multi-group virtual event system. More specifically, in some examples, devices that are embodiments of data processing systems (e.g., smartphones, tablets, personal computers) may be utilized by the attendees and/or hosts of any of the video events provided by the virtual event systems described above. Additionally, or alternative, devices that are embodiments of data processing systems may be utilized to host data storage and/or facilitate data transfer between data processing systems utilized by the virtual event systems described above.

In this illustrative example, data processing system 500 includes a system bus 502 (also referred to as communications framework). System bus 502 may provide communications between a processor unit 504 (also referred to as a processor or processors), a memory 506, a persistent storage 508, a communications unit 510, an input/output (I/O) unit 512, a codec 530, and/or a display 514. Memory 506, persistent storage 508, communications unit 510, input/output (I/O) unit 512, display 514, and codec 530 are examples of resources that may be accessible by processor unit 504 via system bus 502.

Processor unit 504 serves to run instructions that may be loaded into memory 506. Processor unit 504 may comprise a number of processors, a multi-processor core, and/or a particular type of processor or processors (e.g., a central processing unit (CPU), graphics processing unit (GPU), etc.), depending on the particular implementation. Further, processor unit 504 may be implemented using a number of heterogeneous processor systems in which a main processor is present with secondary processors on a single chip. As another illustrative example, processor unit 504 may be a symmetric multi-processor system containing multiple processors of the same type.

Memory 506 and persistent storage 508 are examples of storage devices 516. A storage device may include any suitable hardware capable of storing information (e.g., digital information), such as data, program code in functional form, and/or other suitable information, either on a temporary basis or a permanent basis.

Storage devices 516 also may be referred to as computer-readable storage devices or computer-readable media. Memory 506 may include a volatile storage memory 540 and a non-volatile memory 542. In some examples, a basic input/output system (BIOS), containing the basic routines to transfer information between elements within the data processing system 500, such as during start-up, may be stored in non-volatile memory 542. Persistent storage 508 may take various forms, depending on the particular implementation.

Persistent storage 508 may contain one or more components or devices. For example, persistent storage 508 may include one or more devices such as a magnetic disk drive (also referred to as a hard disk drive or HDD), solid state disk (SSD), floppy disk drive, tape drive, Jaz drive, Zip drive, flash memory card, memory stick, and/or the like, or any combination of these. One or more of these devices may be removable and/or portable, e.g., a removable hard drive. Persistent storage 508 may include one or more storage media separately or in combination with other storage media, including an optical disk drive such as a compact disk ROM device (CD-ROM), CD recordable drive (CD-R Drive), CD rewritable drive (CD-RW Drive), and/or a digital versatile disk ROM drive (DVD-ROM). To facilitate connection of the persistent storage devices 508 to system bus 502, a removable or non-removable interface is typically used, such as interface 528.

Input/output (I/O) unit 512 allows for input and output of data with other devices that may be connected to data processing system 500 (i.e., input devices and output devices). For example, an input device may include one or more pointing and/or information-input devices such as a keyboard, a mouse, a trackball, stylus, touch pad or touch screen, microphone, joystick, game pad, satellite dish, scanner, TV tuner card, digital camera, digital video camera, web camera, and/or the like. These and other input devices may connect to processor unit 504 through system bus 502 via interface port(s). Suitable interface port(s) may include, for example, a serial port, a parallel port, a game port, and/or a universal serial bus (USB).

One or more output devices may use some of the same types of ports, and in some cases the same actual ports, as the input device(s). For example, a USB port may be used to provide input to data processing system 500 and to output information from data processing system 500 to an output device. One or more output adapters may be provided for certain output devices (e.g., monitors, speakers, and printers, among others) which require special adapters. Suitable output adapters may include, e.g., video and sound cards that provide a means of connection between the output device and system bus 502. Other devices and/or systems of devices may provide both input and output capabilities, such as remote computer(s) 560. Display 514 may include any suitable human-machine interface or other mechanism configured to display information to a user, e.g., a CRT, LED, or LCD monitor or screen, etc.

Communications unit 510 refers to any suitable hardware and/or software employed to provide for communications with other data processing systems or devices. While communication unit 510 is shown inside data processing system 500, it may in some examples be at least partially external to data processing system 500. Communications unit 510 may include internal and external technologies, e.g., modems (including regular telephone grade modems, cable modems, and DSL modems), ISDN adapters, and/or wired and wireless Ethernet cards, hubs, routers, etc. Data processing system 500 may operate in a networked environment, using logical connections to one or more remote computers 560. A remote computer(s) 560 may include a personal computer (PC), a server, a router, a network PC, a workstation, a microprocessor-based appliance, a peer device, a smart phone, a tablet, another network note, and/or the like. Remote computer(s) 560 typically include many of the elements described relative to data processing system 500. Remote computer(s) 560 may be logically connected to data processing system 500 through a network interface 562 which is connected to data processing system 500 via communications unit 510. Network interface 562 encompasses wired and/or wireless communication networks, such as local-area networks (LAN), wide-area networks (WAN), and cellular networks. LAN technologies may include Fiber Distributed Data Interface (FDDI), Copper Distributed Data Interface (CDDI), Ethernet, Token Ring, and/or the like. WAN technologies include point-to-point links, circuit switching networks (e.g., Integrated Services Digital networks (ISDN) and variations thereon), packet switching networks, and Digital Subscriber Lines (DSL).

Codec 530 may include an encoder, a decoder, or both, comprising hardware, software, or a combination of hardware and software. Codec 530 may include any suitable device and/or software configured to encode, compress, and/or encrypt a data stream or signal for transmission and storage, and to decode the data stream or signal by decoding, decompressing, and/or decrypting the data stream or signal (e.g., for playback or editing of a video). Although codec 530 is depicted as a separate component, codec 530 may be contained or implemented in memory, e.g., non-volatile memory 542.

Non-volatile memory 542 may include read only memory (ROM), programmable ROM (PROM), electrically programmable ROM (EPROM), electrically erasable programmable ROM (EEPROM), flash memory, and/or the like, or any combination of these. Volatile memory 540 may include random access memory (RAM), which may act as external cache memory. RAM may comprise static RAM (SRAM), dynamic RAM (DRAM), synchronous DRAM (SDRAM), double data rate SDRAM (DDR SDRAM), enhanced SDRAM (ESDRAM), and/or the like, or any combination of these.

Instructions for the operating system, applications, and/or programs may be located in storage devices 516, which are in communication with processor unit 504 through system bus 502. In these illustrative examples, the instructions are in a functional form in persistent storage 508. These instructions may be loaded into memory 506 for execution by processor unit 504. Processes of one or more embodiments of the present disclosure may be performed by processor unit 504 using computer-implemented instructions, which may be located in a memory, such as memory 506.

These instructions are referred to as program instructions, program code, computer usable program code, or computer-readable program code executed by a processor in processor unit 504. The program code in the different embodiments may be embodied on different physical or computer-readable storage media, such as memory 506 or persistent storage 508. Program code 518 may be located in a functional form on computer-readable media 520 that is selectively removable and may be loaded onto or transferred to data processing system 500 for execution by processor unit 504. Program code 518 and computer-readable media 520 form computer program product 522 in these examples. In one example, computer-readable media 520 may comprise computer-readable storage media 524 or computer-readable signal media 526.

Computer-readable storage media 524 may include, for example, an optical or magnetic disk that is inserted or placed into a drive or other device that is part of persistent storage 508 for transfer onto a storage device, such as a hard drive, which is part of persistent storage 508. Computer-readable storage media 524 also may take the form of a persistent storage, such as a hard drive, a thumb drive, or a flash memory, which is connected to data processing system 500. In some instances, computer-readable storage media 524 may not be removable from data processing system 500.

In these examples, computer-readable storage media 524 is a non-transitory, physical or tangible storage device used to store program code 518 rather than a medium that propagates or transmits program code 518. Computer-readable storage media 524 is also referred to as a computer-readable tangible storage device or a computer-readable physical storage device. In other words, computer-readable storage media 524 is media that can be touched by a person.

Alternatively, program code 518 may be transferred to data processing system 500, e.g., remotely over a network, using computer-readable signal media 526. Computer-readable signal media 526 may be, for example, a propagated data signal containing program code 518. For example, computer-readable signal media 526 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 518 may be downloaded over a network to persistent storage 508 from another device or data processing system through computer-readable signal media 526 for use within data processing system 500. For instance, program code stored in a computer-readable storage medium in a server data processing system may be downloaded over a network from the server to data processing system 500. The computer providing program code 518 may be a server computer, a client computer, or some other device capable of storing and transmitting program code 518.

In some examples, program code 518 may comprise an operating system (OS) 550. Operating system 550, which may be stored on persistent storage 508, controls and allocates resources of data processing system 500. One or more applications 552 take advantage of the operating system's management of resources via program modules 554, and program data 556 stored on storage devices 516. OS 550 may include any suitable software system configured to manage and expose hardware resources of computer 500 for sharing and use by applications 552. In some examples, OS 550 provides application programming interfaces (APIs) that facilitate connection of different type of hardware and/or provide applications 552 access to hardware and OS services. In some examples, certain applications 552 may provide further services for use by other applications 552, e.g., as is the case with so-called “middleware.” Aspects of present disclosure may be implemented with respect to various operating systems or combinations of operating systems.

The different components illustrated for data processing system 500 are not meant to provide architectural limitations to the manner in which different embodiments may be implemented. One or more embodiments of the present disclosure may be implemented in a data processing system that includes fewer components or includes components in addition to and/or in place of those illustrated for computer 500. Other components shown in FIG. 5 can be varied from the examples depicted. Different embodiments may be implemented using any hardware device or system capable of running program code. As one example, data processing system 500 may include organic components integrated with inorganic components and/or may be comprised entirely of organic components (excluding a human being). For example, a storage device may be comprised of an organic semiconductor.

In some examples, processor unit 504 may take the form of a hardware unit having hardware circuits that are specifically manufactured or configured for a particular use, or to produce a particular outcome or progress. This type of hardware may perform operations without needing program code 518 to be loaded into a memory from a storage device to be configured to perform the operations. For example, processor unit 504 may be a circuit system, an application specific integrated circuit (ASIC), a programmable logic device, or some other suitable type of hardware configured (e.g., preconfigured or reconfigured) to perform a number of operations. With a programmable logic device, for example, the device is configured to perform the number of operations and may be reconfigured at a later time. Examples of programmable logic devices include, a programmable logic array, a field programmable logic array, a field programmable gate array (FPGA), and other suitable hardware devices. With this type of implementation, executable instructions (e.g., program code 518) may be implemented as hardware, e.g., by specifying an FPGA configuration using a hardware description language (HDL) and then using a resulting binary file to (re)configure the FPGA.

In another example, data processing system 500 may be implemented as an FPGA-based (or in some cases ASIC-based), dedicated-purpose set of state machines (e.g., Finite State Machines (FSM)), which may allow critical tasks to be isolated and run on custom hardware. Whereas a processor such as a CPU can be described as a shared-use, general purpose state machine that executes instructions provided to it, FPGA-based state machine(s) are constructed for a special purpose, and may execute hardware-coded logic without sharing resources. Such systems are often utilized for safety-related and mission-critical tasks.

In still another illustrative example, processor unit 504 may be implemented using a combination of processors found in computers and hardware units. Processor unit 504 may have a number of hardware units and a number of processors that are configured to run program code 518. With this depicted example, some of the processes may be implemented in the number of hardware units, while other processes may be implemented in the number of processors.

In another example, system bus 502 may comprise one or more buses, such as a system bus or an input/output bus. Of course, the bus system may be implemented using any suitable type of architecture that provides for a transfer of data between different components or devices attached to the bus system. System bus 502 may include several types of bus structure(s) including memory bus or memory controller, a peripheral bus or external bus, and/or a local bus using any variety of available bus architectures (e.g., Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI)).

Additionally, communications unit 510 may include a number of devices that transmit data, receive data, or both transmit and receive data. Communications unit 510 may be, for example, a modem or a network adapter, two network adapters, or some combination thereof. Further, a memory may be, for example, memory 506, or a cache, such as that found in an interface and memory controller hub that may be present in system bus 502.

### C. Illustrative Distributed Data Processing System

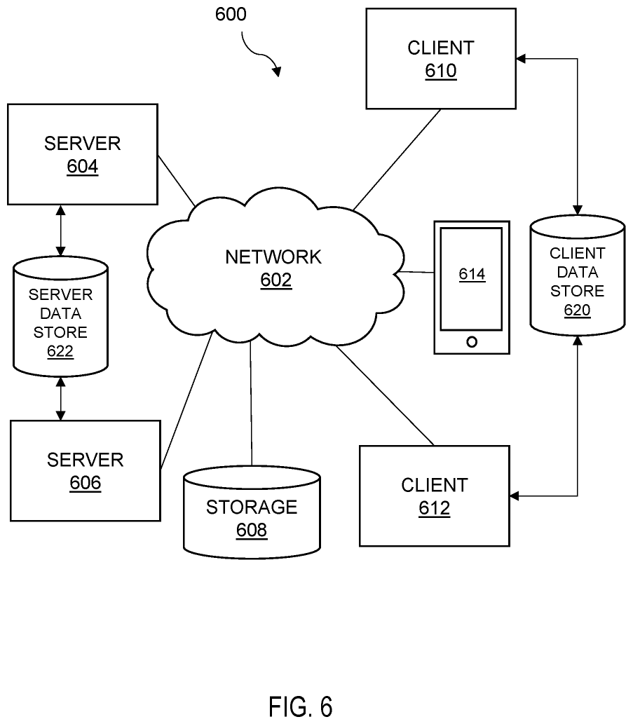

As shown in FIG. 6, this example describes a general network data processing system 600, interchangeably termed a computer network, a network system, a distributed data processing system, or a distributed network, aspects of which may be included in one or more illustrative embodiments of the multi-group virtual event systems described above. For example, the audio and video data transfer between the attendees and the host may be provided by network system 600.

It should be appreciated that FIG. 6 is provided as an illustration of one implementation and is not intended to imply any limitation with regard to environments in which different embodiments may be implemented. Many modifications to the depicted environment may be made.

Network system 600 is a network of devices (e.g., computers), each of which may be an example of data processing system 500, and other components. Network data processing system 600 may include network 602, which is a medium configured to provide communications links between various devices and computers connected within network data processing system 600. Network 602 may include connections such as wired or wireless communication links, fiber optic cables, and/or any other suitable medium for transmitting and/or communicating data between network devices, or any combination thereof.

In the depicted example, a first network device 604 and a second network device 606 connect to network 602, as do one or more computer-readable memories or storage devices 608. Network devices 604 and 606 are each examples of data processing system 500, described above. In the depicted example, devices 604 and 606 are shown as server computers, which are in communication with one or more server data store(s) 622 that may be employed to store information local to server computers 604 and 606, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 610 and 612 and/or a client smart device 614, may connect to network 602. Each of these devices is an example of data processing system 500, described above regarding FIG. 5. Client electronic devices 610, 612, and 614 may include, for example, one or more personal computers, network computers, and/or mobile computing devices such as personal digital assistants (PDAs), smart phones, handheld gaming devices, wearable devices, and/or tablet computers, and the like. In the depicted example, server 604 provides information, such as boot files, operating system images, and applications to one or more of client electronic devices 610, 612, and 614. Client electronic devices 610, 612, and 614 may be referred to as “clients” in the context of their relationship to a server such as server computer 604. Client devices may be in communication with one or more client data store(s) 620, which may be employed to store information local to the clients (e.g., cookie(s) and/or associated contextual information). Network data processing system 600 may include more or fewer servers and/or clients (or no servers or clients), as well as other devices not shown.

In some examples, first client electric device 610 may transfer an encoded file to server 604. Server 604 can store the file, decode the file, and/or transmit the file to second client electric device 612. In some examples, first client electric device 610 may transfer an uncompressed file to server 604 and server 604 may compress the file. In some examples, server 604 may encode text, audio, and/or video information, and transmit the information via network 602 to one or more clients.

Client smart device 614 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and/or other devices to form a mobile network where information can be exchanged.

Data and program code located in system 600 may be stored in or on a computer-readable storage medium, such as network-connected storage device 608 and/or a persistent storage 508 of one of the network computers, as described above, and may be downloaded to a data processing system or other device for use. For example, program code may be stored on a computer-readable storage medium on server computer 604 and downloaded to client 610 over network 602, for use on client 610. In some examples, client data store 620 and server data store 622 reside on one or more storage devices 608 and/or 508.

Network data processing system 600 may be implemented as one or more of different types of networks. For example, system 600 may include an intranet, a local area network (LAN), a wide area network (WAN), or a personal area network (PAN). In some examples, network data processing system 600 includes the Internet, with network 602 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational, and other computer systems may be utilized to route data and messages. In some examples, network 602 may be referred to as a “cloud.” In those examples, each server 604 may be referred to as a cloud computing node, and client electronic devices may be referred to as cloud consumers, or the like. FIG. 6 is intended as an example, and not as an architectural limitation for any illustrative embodiments.

### D. Illustrative Combinations and Additional Examples

This section describes additional aspects and features of a multi-group virtual event system, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.
A0. A computer implemented method for hosting a virtual event, the method comprising:
   receiving, via a user interface, a plurality of login credentials, each login credential corresponding to a respective attendee and comprising a respective group identifier;
   grouping the attendees into one or more groups based on the respective group identifiers;
   restricting video and audio communication between attendees to include only other attendees of the same group; and
   sending digital media of the host including a video stream of the host and/or an audio stream of the host to each of the attendees.
A1. The computer implemented method of paragraph A0, further comprising:
   receiving, via the user interface, a second plurality of login credentials, each second login credential corresponding to a respective attendee and comprising a request to join a random group;
   grouping one or more of the attendees corresponding to the second plurality of login credentials into the same group.
A2. The computer implemented method of A0 and/or A1, further comprising:
   receiving from the host a selected subset of attendees;
   sending a video stream and/or an audio stream of each of the selected subset of attendees to each other attendee.
A3. The computer implemented method of any one of paragraphs A0-A2, further comprising:
   receiving from the host a selected subset of attendees;
   sending a video stream and/or an audio stream of each of the selected subset of attendees to the host.
A4. The computer implemented method of any one of paragraphs A0-A3, further comprising:
   rendering a virtual space and rendering each attendee as a virtual avatar within the virtual space; and
   rendering the digital media of the host as a virtual media object within the virtual space.
A5. The computer implemented method of paragraph A4, further comprising:
   controlling a volume of the audio communication between attendees based on a virtual proximity to other attendees within the virtual space.
A6. The computer implemented method of any one of paragraphs A0-A5, further comprising:
   automatically lowering an audio volume of an attendee based on the volume reaching a selected volume threshold.
A7. The computer implemented method of any one of paragraphs A0-A6, further comprising:
   automatically lowering a respective audio volume of all attendees except a selected subset of attendees.
A8. The computer implemented method of paragraph A7, wherein the selected subset is selected by the host.
A9. The computer implemented method of paragraph A8, wherein the selected subset comprises a selected one of the one or more groups.
B0. A data processing system for hosting a virtual event, the system comprising:
   one or more processors;
   a memory; and
   a plurality of instructions stored in the memory and executable by the one or more processors to:
      receive, via a user interface, a plurality of login credentials, each login credential corresponding to a respective attendee and comprising a respective group identifier;
      group the attendees into one or more groups based on the respective group identifiers;
      restrict video and audio communication between attendees to include only other attendees of the same group; and
      send digital media of the host including a video and/or audio stream to each attendee.
B1. The data processing system of paragraph B0, the plurality of instructions further configured to:
   receive, via the user interface, a second plurality of login credentials, each second login credential corresponding to a respective attendee and comprising a request to join a random group;
   group one or more of the attendees corresponding to the second plurality of login credentials into the same group.
B2. The data processing system of paragraph B0 and/or B1, the plurality of instructions further configured to:
   receive from the host a selected subset of attendees;
   send a video stream and/or an audio stream of each of the selected subset of attendees to each other attendee.
B3. The data processing system of any one of paragraphs B0-B2, the plurality of instructions further configured to:
   receive from the host a selected subset of attendees;
   send a video stream and/or an audio stream of each of the selected subset of attendees to the host.
B4. The data processing system of any one of paragraphs B0-B3, the plurality of instructions further configured to:
   render a virtual space and render each attendee as a virtual avatar within the virtual space;
   render the digital media of the host as a virtual media object within the virtual space.
B5. The data processing system of any one of paragraphs B0-B4, the plurality of instructions further configured to:
   control a volume of the audio communication between attendees based on a virtual proximity to other attendees within the virtual space.
B6. The data processing system of any one of paragraphs B0-B5, the plurality of instructions further configured to:
   automatically lower a volume of an attendee based on the volume reaching a selected volume threshold.
B7. The data processing system of any one of paragraphs B0-B6, the plurality of instructions further configured to:
   automatically lower a respective volume of all attendees except a selected subset of attendees.
B8. The data processing system of paragraph B7, wherein the selected subset is selected by the host.
B9. The data processing system of paragraph B8, wherein the selected subset comprises a selected one of the one or more groups.
C0. Virtual event systems of the present disclosure, including any combination of A and/or B paragraphs above, may include the following operating modes:
   Full Group Mode—Attendees are only able to see and hear other attendees that are members of their group along with the host and anyone in the spotlight.
   Audio Group Mode—Attendees can see everyone but can only hear other attendees that are members of their group along with the host and anyone in the spotlight.
   Group Mode—Attendees can see and hear everyone as if they are not in group mode at all. However, system interactions and layouts are aware of group membership, and attendees' tiles are organized by groups, scores are kept by groups, etc.
   Regular Mode—Attendees are not grouped.

### Advantages, Features, and Benefits

The different embodiments and examples of the multi-group virtual event system described herein provide several advantages over known solutions for a host to provide video/media presentations to a plurality of distinct groups of attendees. For example, illustrative embodiments and examples described herein replicate the real-world scenario of attending an event in the virtual world.

Additionally, and among other benefits, illustrative embodiments and examples described herein offer the same virtual experience to multiple teams or customers simultaneously.

Additionally, and among other benefits, illustrative embodiments and examples described herein may help subsidize the cost of a unique experience to a customer. For example, utilizing other, known solutions a group may pay a large price for an exclusive virtual event with the expectation of privacy. Alternatively, the multi-group virtual event system described herein may provide the same experience to multiple groups at a lower cost per group, thereby providing a higher revenue source for the host while maintaining the same level of exclusivity for each group.

Additionally, and among other benefits, illustrative embodiments and examples described herein enable the following functionality:
The ability for all groups to see/hear the host while in Full Group Mode or Audio Group Mode.
The ability for all group to see/hear participants in spotlight while in Full Group Mode or Audio Group Mode.
The ability for a participant to be placed in/out of spotlight, thereby impacting who can hear/see that participant dynamically.
Audio Group Mode & Group Mode capabilities such as:
   Interactions between groups (e.g., games, etc.) are group aware and can do things like: lock in an answer from a group when the first participant in the group responds, round-robin amongst group members, etc.
   Layouts are group aware so that a group's members can be consolidated in a specific area within the screen or virtual space.
   The ability to fluidly transition between group modes without delay.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A computer implemented method for hosting a virtual event, the method comprising:
receiving, via a user interface, a plurality of login credentials, each login credential corresponding to a respective attendee and comprising a respective group identifier;
grouping the attendees into one or more groups based on the respective group identifiers;
restricting video and audio communication between attendees to include only other attendees of the same group; and
sending digital media of the host including a video stream of the host and/or an audio stream of the host to each of the attendees.

2. The computer implemented method of claim 1, further comprising:
receiving, via the user interface, a second plurality of login credentials, each second login credential corresponding to a respective attendee and comprising a request to join a random group;
grouping one or more of the attendees corresponding to the second plurality of login credentials into the same group.

3. The computer implemented method of claim 1, further comprising:
receiving from the host a selected subset of attendees;
sending a video stream and/or an audio stream of each of the selected subset of attendees to each other attendee.

4. The computer implemented method of claim 1, further comprising:
receiving from the host a selected subset of attendees;
sending a video stream and/or an audio stream of each of the selected subset of attendees to the host.

5. The computer implemented method of claim 1, further comprising:
rendering a virtual space and rendering each attendee as a virtual avatar within the virtual space; and
rendering the digital media of the host as a virtual media object within the virtual space.

6. The computer implemented method of claim 5, further comprising:
controlling a volume of the audio communication between attendees based on a virtual proximity to other attendees within the virtual space.

7. The computer implemented method of claim 1, further comprising:
automatically lowering an audio volume of an attendee based on the volume reaching a selected volume threshold.

8. The computer implemented method of claim 1, further comprising:
automatically lowering a respective audio volume of all attendees except a selected subset of attendees.

9. The computer implemented method of claim 8, wherein the selected subset is selected by the host.

10. The computer implemented method of claim 9, wherein the selected subset comprises a selected one of the one or more groups.

11. A data processing system for hosting a virtual event, the system comprising:
one or more processors;
a memory; and
a plurality of instructions stored in the memory and executable by the one or more processors to:
receive, via a user interface, a plurality of login credentials, each login credential corresponding to a respective attendee and comprising a respective group identifier;
group the attendees into one or more groups based on the respective group identifiers;
restrict video and audio communication between attendees to include only other attendees of the same group; and
send digital media of the host including a video and/or audio stream to each attendee.

12. The data processing system of claim 11, the plurality of instructions further configured to:
receive, via the user interface, a second plurality of login credentials, each second login credential corresponding to a respective attendee and comprising a request to join a random group;
group one or more of the attendees corresponding to the second plurality of login credentials into the same group.

13. The data processing system of claim 11, the plurality of instructions further configured to:
receive from the host a selected subset of attendees;
send a video stream and/or an audio stream of each of the selected subset of attendees to each other attendee.

14. The data processing system of claim 11, the plurality of instructions further configured to:
receive from the host a selected subset of attendees;
send a video stream and/or an audio stream of each of the selected subset of attendees to the host.

15. The data processing system of claim 11, the plurality of instructions further configured to:
render a virtual space and render each attendee as a virtual avatar within the virtual space;
render the digital media of the host as a virtual media object within the virtual space.

16. The data processing system of claim 15, the plurality of instructions further configured to:
control a volume of the audio communication between attendees based on a virtual proximity to other attendees within the virtual space.

17. The data processing system of claim 11, the plurality of instructions further configured to:
automatically lower a volume of an attendee based on the volume reaching a selected volume threshold.

18. The data processing system of claim 11, the plurality of instructions further configured to:
automatically lower a respective volume of all attendees except a selected subset of attendees.

19. The data processing system of claim 18, wherein the selected subset is selected by the host.

20. The data processing system of claim 19, wherein the selected subset comprises a selected one of the one or more groups.
